(19) United States
(12) Patent Application Publication
(10) Pub. No.: US 2026/0326038 A1
(43) Pub. Date: Oct. 22, 2026

(54) FILTRATION SYSTEM AND AUTOMATED FILTRATION PROCESS FOR TESTING LIQUIDS USING CONSUMABLE FILTRATION UNITS

(71) Applicant: Merck Patent GmbH, Darmstadt (DE)

(72) Inventors: Gael Waiche, Strasbourg (FR); Francois Oblinger, Dinsheim Sur Bruche (FR); Vincent Schaal, Kintzheim (FR)

(21) Appl. No.: 19/115,897

(22) PCT Filed: Sep. 28, 2023
(86) PCT No.: PCT/EP2023/076844

§ 371 Date: Mar. 27, 2025

(30) Foreign Application Priority Data
Oct. 4, 2022 (EP) 22306473.4

(51) Int. Cl. B01D 63/08

(52) U.S. Cl. CPC B01D 63/087; B01D 2313/10; B01D 2313/12; B01D 2313/13; B01D 2313/58; B01D 2313/903

(57) ABSTRACT

The present application relates to a filtration system and to an automated filtration process for testing liquids using consumable filtration units.

### TECHNICAL FIELD

The present application relates to a filtration system and to an automated filtration process for testing liquids using consumable filtration units.

### BACKGROUND

In the fields of biomonitoring and bioburden testing, water testing, pharmaceutical, cosmetics, food processing, semiconductor production, electronics, and environmental (water) monitoring, common laboratory testing equipment used in connection with testing processes requiring filtration of a liquid, in most cases of a biological liquid, comprises closed consumable (one-way use) filtration units or filtration assemblies, which typically comprise a base with a drain, a funnel attached to the base, a filtration membrane arranged on the base between a space or volume defined by the funnel and the drain, and a lid or cover (in the following only the term “lid” will be used) for closing an upper opening of the funnel, mostly in a snap-fit or form-locking connection with a peripheral edge of the opening of the funnel, and with or without a hinge defining the relative movement between the lid and the funnel.

A typical example of a ready-to-use, sterile filtration unit of this type with a filtration or funnel volume of 100 mL and a gridded membrane filter with a diameter of 49 mm in a single device offering a complete solution for bioburden testing is, for example, commercially available from Merck KGAA, Darmstadt, Germany, under the trademark MILLIFLEX OASIS.

Some filtration units or filtration assemblies (in the following only the term “filtration unit” will be used) are not particularly suitable for automated handling. It is in particular difficult for automated handling equipment to securely grip, hold and transfer the frequently smooth or thin and subtle peripheral outer surfaces with an irregular shape or of its parts like the lid as they require a defined position and orientation for gripping, and there is a high risk that lids are inadvertently or erratically opened, displaced, or removed or contents spilled during handling at the various stages of the process, thereby compromising the detection result by cross-contamination or posing a safety issue for operators. Another aspect is that traceability of every testing operation must be ensured, which also demands that the steps of the processes are exactly repeated each time such process is performed.

Some of the handling steps like the opening of snap-fit lids involve a rather complex sequence or pattern of holding tasks and of tasks for application of force or momentum because the force for overcoming an initially high friction of the snap-fit connection must be quickly reduced to avoid spillage in the further process. This is why manual handling is still commonly done in such testing processes.

Obviously, the manual handling of such equipment involves a risk of contamination during handling, for example after the lid, cover or seal has been opened, and a non-secure transfer of the equipment of components thereof in the further handling, in particular when the equipment is filled with substances and/or a plurality of tests are handled serially.

Automation is becoming a privileged approach used by, for example, pharmaceutical companies in their critical processes in order to reduce the risk of cross-contamination, increase quality and improve the throughput. There is a general industry trend towards fully automatized processes.

Nevertheless, the automation of a process requires a significant level of investment and available space to comply with regulations. Automation may require large systems with potentially dangerous devices enclosed in cells that may also be costly to maintain. This is why many users seek solutions that are less costly and/or require less room or footprint to automate certain processes.

This is why an alternative way to automate certain processes is to design small integrated dedicated modules that are capable of performing specific tasks. Such systems may be designed to fit into an existing lab infrastructure and can greatly facilitate their integration therein. Other examples are collaborative robots as these robots can safely interact with humans and thus can be more easily integrated into a laboratory or production environment without significant investments.

Nevertheless, those solutions are made to handle limited and basic tasks, such as pipetting, lifting, transferring. They do not have the polyvalence and adaptability to perform whole workflows requiring the complex handling of consumables.

Another alternative solution to handle the automated filtering of consumables may be an automated system that can handle a whole process thanks to the combination of robot-arms and tools that can mimic a human operator. A two-arm robot could achieve the complex tasks required for the filtration with the right set of tools and support adapted for the consumables. Nevertheless, this system is too large and polyvalent for most applications. The operations required on some consumables are so specific that adapting a complex robot cell would not be an efficient way to perform the process. Moreover, with a centralized handler that processes every step of the filtration, the scalability of the solution is greatly limited.

US 2015/0322400 A1 discloses an automatic cell detachment system that includes a cover removing device, a pipette device, a cell observing device, and an automatic cell detachment device that are disposed on both sides of a central rail. A general-purpose robot used as a transfer device for culture vessels in the form of discoid transparent dishes from an incubator to the various devices of the system is provided to be runnable along the rail. The robot includes a multi-jointed arm and a hand with a pair of rod-shaped fingers for sandwiching the sides of the culture vessel mounted to the distal end of the arm. When removed from the inside of the incubator, the culture vessel is in the state of being covered by a cover. The cover removing device is a device for removing the cover from the culture vessel and includes a suction pad connected to a vacuum pump. The robot transfers the culture vessel covered by the cover to immediately below the suction pad, then vertically lifts the culture vessel such that the cover is sucked and held by the suction pad, and thereafter vertically lowers the culture vessel. In this manner, the cover is removed from the culture vessel. The cover removing device includes a turning mechanism configured to turn an arm supporting the suction pad. Each cover sucked and held by the suction pad is stacked up at a storage position adjacent to the suction position. The cover removing device may include a lifting/lowering mechanism for lifting and lowering the suction pad.

U.S. Pat. No. 9,631,223 B2 discloses a method of processing liquid biological material in a liquid processing system. The liquid processing system includes a frame which defines a predetermined workspace, physiochemical equipment and a workbench disposed within the frame, and a general-purpose two-arm robot disposed within the frame. The frame sections form a rectangular workspace and defines the operable range of the robot. The physiochemical equipment is situated in the range of the arms of the robot and includes biological lab instruments and consumables which operate off of an electric power supply, single-use general-purpose containers and instruments, racks for holding general-purpose containers, and so forth.

Automation of a filtration system and a filtration process for testing liquids using consumable filtration units is, however, subject to specific challenges for several reasons:
It is necessary to ensure the safety of a filtration device, i.e. it is often required to protect the membrane with. for example inside, a closed container when it is not used or processed. Then, during the operation, the container lid must be opened safely to perform the filtration. This requires a combination of consumable handling and fluid management while managing risks of cross contamination;
The automated solution should be compatible with existing consumables and workflows to facilitate the user adoption. Nevertheless, existing consumables are made for manual use. Some tasks can be complex to replicate as they require a combination of muscular compliance, delicate handling, and an accurate monitoring of the operations;
The user must fit the automated system in the existing labs. Therefore, automation must be adapted to the user's needs and resources by limiting the size of the automated system;
Finally, the filtering process is often a part of a routine testing made in high volume. To be efficient and ecological for the user, a solution should be able to automate the process with a high throughput and repeatability and good scalability.

An object to be solved by the invention is thus to provide a filtration system and an automated filtration process for testing liquids using subtle consumable filtration units, which achieve a safe, fast, simple and traceable autonomous filtration process despite of its intrinsic complexity in a small footprint.

### SUMMARY

The invention relates to a filtration system and to an automated filtration process for testing liquids using consumable filtration units.

In order to solve the problem described above, the present invention provides a filtration system with the features of claim 1 and an automated filtration process with the features of claim 13. Preferred embodiments of the filtration system and of the filtration process are defined in the dependent claims.

The invention in particular provides a filtration system for testing liquids using consumable filtration units, such filtration units each comprising a base with a drain, a funnel attached to the base, a membrane arranged on the base between a space defined by the funnel and the drain, and a lid for closing an upper opening of the funnel, the filtration system comprising:
a support for receiving the consumable filtration unit, the support including locking means configured to releasably fix the filtration unit on the support;
a liquid flow path having one side communicating with a downstream side of the drain when the filtration unit is fixed to the support, another side of the liquid flow path adapted to be connected to a pump for withdrawing liquid from the drain when the filtration unit is fixed to the support; and
a weighing sensor arranged to detect the weight of the filtration unit fixed to the support.

In the filtration system the weighing sensor is preferably arranged to monitor the combined weight of the support with the filtration unit fixed to the support.

The filtration system preferably comprises an elastic support element that connects the support to a fixed frame or base so as to provide for motion of the support in the direction of gravity.

In the filtration system, the elastic support element preferably comprises an elastic foil or membrane arranged so as to shield components below the support from spillage of liquid from the filtration unit.

The filtration system preferably comprises a mechanical manipulator for selectively engaging with the lid on the filtration unit and for moving the engaged lid to selectively open/close the upper opening of the funnel.

In the filtration system, the mechanical manipulator preferably comprises a manipulator arm configured to selectively engage with a portion of the lid, the manipulator arm being pivotable around a horizontal manipulator axis, which manipulator axis is preferably parallel or coaxial with a pivot axis of the lid attached to the funnel of the filtration unit.

In the filtration system, the manipulator arm preferably supports a suction cup for engaging with a portion of an outer surface of the lid.

The filtration system preferably comprises an unlocking actuator configured to initially unlock the lid from engagement with a rim of the funnel, preferably by applying an upward pulling or pushing force onto a section of an outer peripheral portion of the lid.

In the filtration system, the operation of the unlocking actuator preferably is coordinated with the operation of the mechanical manipulator.

The filtration system preferably comprises an arrangement of jaws configured to selectively engage with the outer periphery of the filtration unit, the operation of the arrangement of jaws preferably coordinated with the operation of the mechanical manipulator and/or the unlocking actuator, if provided.

In the filtration system, the unlocking actuator is preferably mounted to one of the jaws.

The filtration system preferably comprises a controller arranged to communicate with the weighing sensor, the locking means of the support, the mechanical manipulator, if provided, and the unlocking actuator, if provided, the controller configured to control the operation of these components autonomously based on the detection result of the weighing sensor and a predefined operation sequence.

The invention in particular also provides an automated filtration process for testing liquids using consumable filtration units, such filtration units each comprising a base with a drain, a funnel attached to the base, a membrane arranged on the base between a space defined by the funnel and the drain, and a lid for closing an upper opening of the funnel, and using a filtration system according to the invention that includes the mechanical manipulator and the unlocking actuator, the filtration process comprising the following steps, preferably in sequence:
a) placing the filtration unit on the support, preferably by an external apparatus, detecting the presence of the filtration unit on the support using the weighing sensor, and, in the affirmative, operating the locking means to fix the filtration unit on the support;
b) operating the manipulator arm of the mechanical manipulator to engage with a portion of the lid, and applying a force onto the lid in the closing direction thereof;
c) engaging the unlocking actuator with a section of an outer peripheral portion of the lid and applying an upward pulling or pushing force to the section to unlock the lid from engagement with a rim of the funnel while maintaining application of a certain force onto the lid in the closing direction by the mechanical manipulator;
d) disengaging and separating the unlocking actuator and the manipulator arm of the mechanical manipulator from the lid and taring the weighing sensor;
e) operating the manipulator arm of the mechanical manipulator to engage with the portion of the lid, and applying a force onto the lid in the opening direction thereof;
f) introducing a defined amount of the liquid to be tested into the space of the funnel, preferably using the weighing sensor to monitor and control the introduced amount;
g) operating the manipulator arm of the mechanical manipulator and applying a force onto the lid in the closing direction to bring the lid into a posture where it preferably substantially closes the opening of the funnel but is in any case not locked to the rim of the funnel;
h) withdrawing the liquid to be tested from the funnel through the liquid flow path via the membrane and the drain of the filtration unit using a pump connected to the other side of the liquid flow path, preferably using the weighing sensor to monitor and control the withdrawn amount;
i) operating the manipulator arm of the mechanical manipulator and applying a force onto the lid in the closing direction to bring the lid into a posture where it is locked to the rim of the funnel; and
j) disengaging and separating the manipulator arm of the mechanical manipulator from the lid, operating the locking means to release fixation of the filtration unit on the support, and removing the filtration unit from the support, preferably by an external apparatus.
The automated filtration process preferably comprises, in step a), aligning an axis of a hinge of the lid with the manipulator axis of the manipulator arm of the mechanical manipulator before operating the locking means to fix the filtration unit on the support.

The automated filtration process preferably comprises, in step c), engaging the arrangement of jaws with the outer periphery of the filtration unit before engaging the unlocking actuator with the section of the outer peripheral portion of the lid and applying the upward pulling or pushing force to the section to unlock the lid from engagement with the rim of the funnel; and in step d), disengaging the arrangement of jaws from the outer periphery of the filtration unit, before taring the weighing sensor.

### BRIEF DESCRIPTION OF THE DRAWINGS

The present invention will in the following be described in detail on the basis of preferred but non-limiting embodiments and some variants by reference to the attached exemplary schematic drawings, in which

FIG. 1 shows a schematic side view of a filtration system according to a first embodiment in a partial sectional view;

FIG. 2 shows a detail of the unlocking actuator of the first embodiment;

FIG. 3 shows a detail of the unlocking actuator of a second embodiment;

FIGS. 4a to 4i show a sequence of characteristic steps of an automated filtration process using the filtration system according to the first embodiment;

FIGS. 5a to 5i show a sequence of characteristic steps of an automated filtration process using the filtration system according to the second embodiment;

FIG. 6 shows a variant of the first embodiment in which an alternative concept of the unlocking actuator is implemented; and

FIG. 7 shows a detail of one variant of the manipulator for engaging with the lid of the filtration unit.

### DETAILED DESCRIPTION

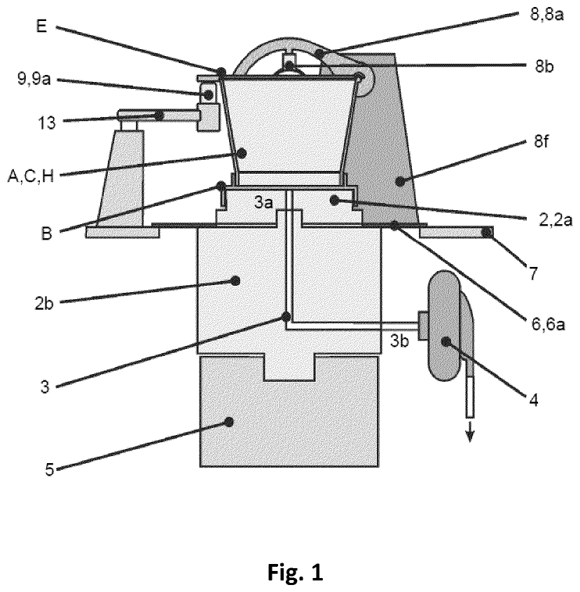

The invention is now described in connection with the first embodiment shown in FIG. 1. It is remarked that functions and structural or conceptual features of the individual components of the filtration system according to the first embodiment will additionally be described in connection with the second embodiment, the variants and the filtration process described further below.

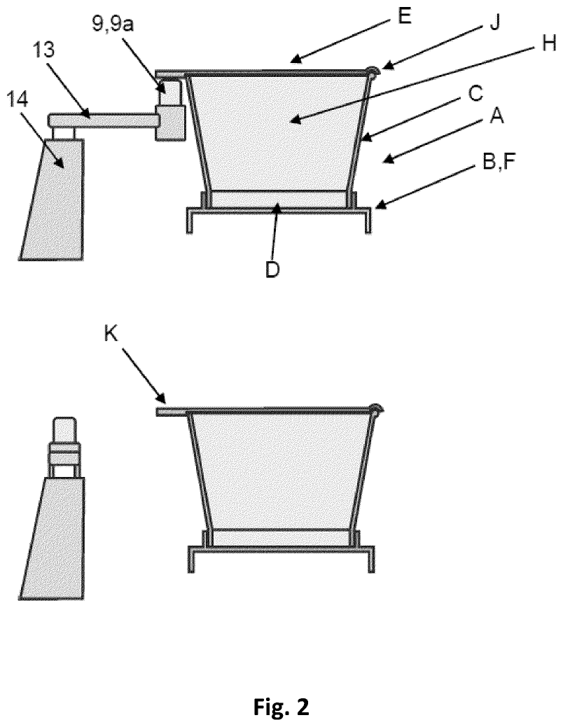

The filtration system 1 is specifically designed for testing liquids using consumable filtration units A of the type known in the art and generally described above (FIG. 1 shows the filtration unit A arranged in the system; see also FIG. 2). Such filtration units A each comprise a base B with a drain F (integral or as a separate component), a funnel C attached to the base B (the term “attached” may, depending on the type, also include “integral” although a structure made from two components assembled or attached together in a fixed or separable manner is most frequently used), a filtration membrane D arranged on the base B between a space or volume H defined by the funnel C and the drain F, and a lid or cover E for closing an upper opening of the funnel C.

In the example used for describing the invention the lid or cover E is attached with a snap-fit or form-locking connection with a peripheral edge of the opening of the funnel to avoid inadvertent opening during handling, and the lid is connected to the funnel with a hinge J defining the relative movement between the lid and the funnel. The lid is also provided with a tab K protruding radially outward from the peripheral edge of the lid. These aspects are preferred but are not absolutely necessary.

In use the lid is opened, and a liquid to be tested is filled into the space or volume H of the funnel, forced through the filtration membrane D and subsequently discharged for disposal or further processing. The filtration membrane D is then subjected to further processing and evaluation.

The filtration system 1 comprises a support 2 for removably receiving the consumable filtration unit A. The support 2 includes locking means 2b configured to releasably actively fix and seal the filtration unit A on a receptacle 2a of the support 2. The locking means 2b is thus understood to provide the function of a head tightening actuator. The part of the support 2 in direct contact with the base B of the filtration unit is referred to as a “head” that is designed to be removable for cleaning potentially contaminated outer surfaces and internal channels through which the filtrate withdrawn from the space H of the filtration unit A is directed to a liquid flow path 3 of the filtration system 1 under the action of an external suction or aspiration pump 4.

This removable part or head of the support 2 may also be designed to receive plural filtration units A communicating with a common internal manifold (not shown), or to receive one or plural filtration units of different type or size.

The head tightening actuator or locking means 2b is capable of producing, in a controlled manner, a force transmitted to the part of the support in contact with the filtration unit A, i.e. the receptacle 2a, to activate a sealing feature. The sealing feature comprises a lockable mechanical and fluidic interface with respect to the filtration unit A.

The locking function can be realized by a vacuum or sub-ambient pressure selectively generated at an interface between the receptacle of the support 2 and the base B of the filtration unit A by a vacuum pump (not shown) or a mechanical lock (not shown) that selectively engages surfaces or locking features on the base B of the filtration unit A to force and hold it in place on the receptacle 2a of the support 2. Details of these components are not described and can be changed as long as the function of releasably holding the base in the receptacle of the support in a sealed manner is fulfilled.

The internal channels of the support 2 form a liquid flow path 3 having one side 3a communicating with a downstream side of the drain F when the filtration unit A is fixed and sealed to the support 2. Another side 3b of the liquid flow path 3 is adapted to be connected to a pump 4 for withdrawing liquid from the drain F when the filtration unit A is fixed to the support 2. The liquid flow path 3 channels the filtrate coming from the filtration unit A to the suction or aspiration pump 4 from which the liquid is exhausted to a tubing (not shown) downstream into a collection container.

The filtration system 1 further comprises a weighing sensor or scale 5 connected to a fixed base or system frame (not shown in detail) and arranged to measure and detect the combined weight of the support 2 and the weight of the filtration unit A (and of its liquid content in the space H) fixed to the support 2 all along the process. As the weight of the functional components of the system is known, changes or variations of the weight monitored over time during the process are attributable and thus indicative to changes caused by the filtration unit A being either fixed to the support or absent, and of changes of the amount of its content. The expected changes over time in a defined and known process and/or the gradient of changes can be evaluated and used to determine the correctness or completion of certain steps or the volume of the liquid to be tested existing in the space of the funnel at any one point of time. It can be also used as an input into a controller of the system to trigger operation and control the components of the system to achieve an autonomous and automatic process as described further below.

The filtration system 1 may comprise an elastic support element 6 that connects the support 2 to a fixed frame or base 7 so as to provide for a substantially unimpeded relative motion of the support 2 in the direction of gravity at least. This motion—typically induced by the above changes of the weight of the support due to the attachment of the filtration unit or filling/extraction of the liquid to be tested in the funnel—is detected by the weighing sensor or scale 5. Depending on the type of weighing sensor or scale 5, the relative motion may be very small as known from commercially available scales.

The elastic support element 6, may, for example, comprise elastic support strings or bands or springs (all not shown) as is known in the art and serves to make the support 2 mechanically free from the frame to allow the weight measurement to be possible. The elastic support element 6, may also, for example, comprise a watertight elastic foil or membrane 6a as shown in FIG. 1 arranged so as to shield components below the receptacle 2a of the support 2 from spillage of liquid from the filtration unit A. In other words, only the removable part of the support with the receptacle 2a for the filtration units A (i.e. the head) may be located above the elastic foil or membrane 6a. It is noted that this shielding function may be provided by the elastic foil or membrane 6a independent from the elastic support of the support 2 for the weighing function that may be realized by a separate component.

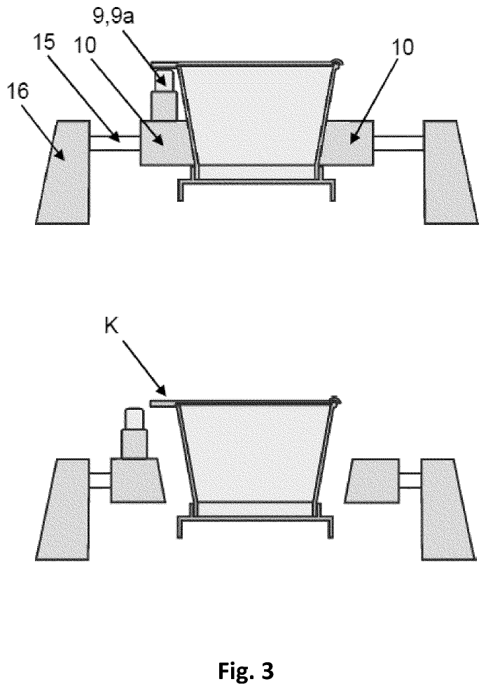

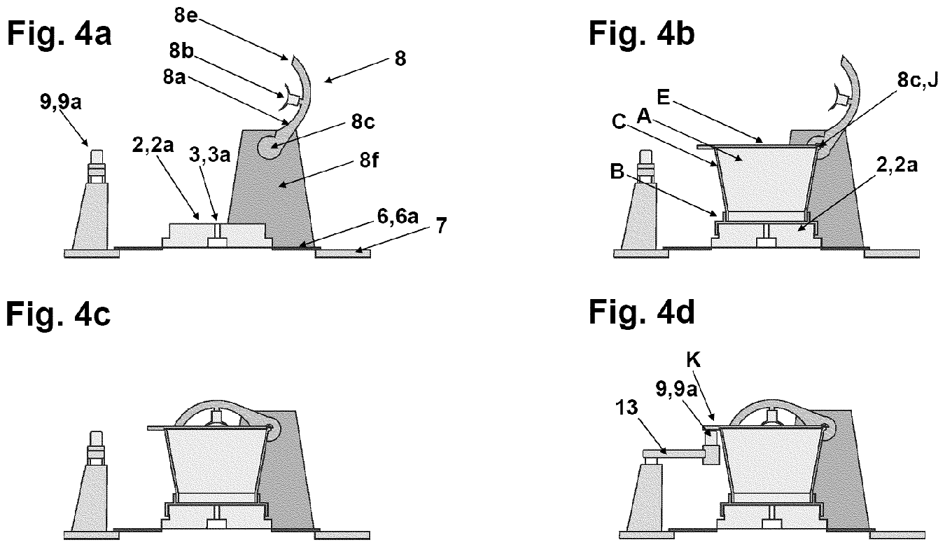

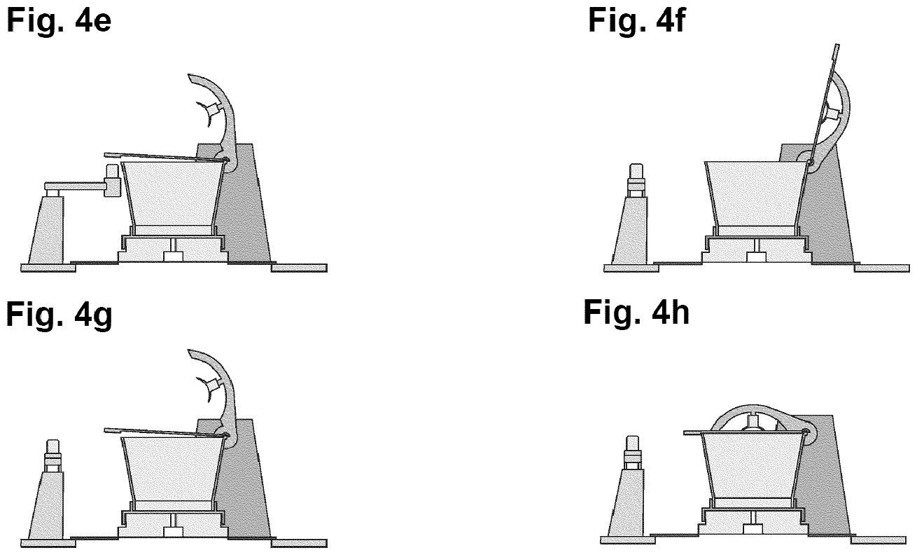

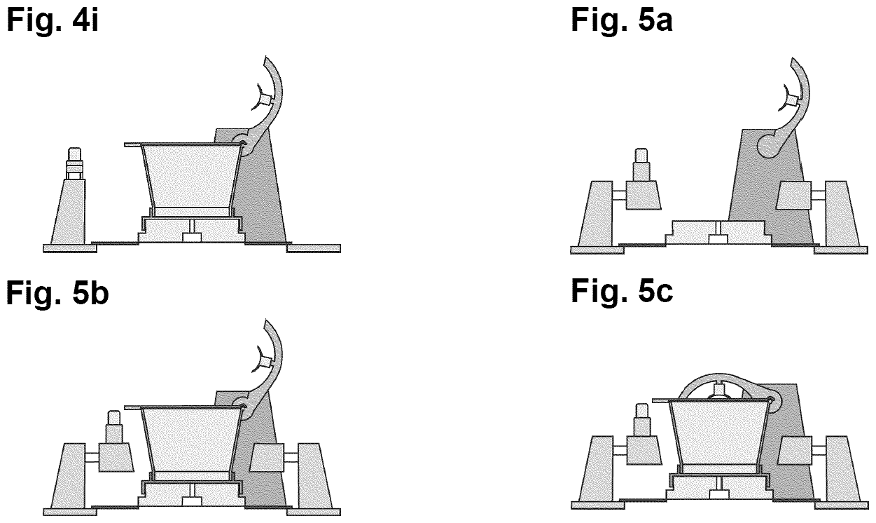

The filtration system 1 (see, for example, FIG. 4a) comprises a mechanical manipulator 8 for selectively engaging with the lid E on the filtration unit A and for moving the engaged lid E to selectively open/close the upper opening of the funnel C to provide access to the space or volume H. The mechanical manipulator 8 comprises a manipulator arm 8a configured to selectively engage with a portion of the lid E, the manipulator arm 8a being pivotable around a horizontal manipulator axis 8c that can be realized by a manipulator rotation shaft 8d protruding laterally from the manipulator arm 8a or integrated with it and arranged to be selectively driven for rotation about the manipulator axis 8c in opposite directions by means of a manipulator actuator 8f. The rotation shaft 8d may of course be a part of the actuator 8f that is connected to the manipulator arm to transmit the drive momentum.

The manipulator actuator 8f may be a hydraulic/pneumatic motor or an electric motor, preferably a servo motor. A rotational actuator as mentioned may be replaced by a linear actuator combined with a suitable transmission link. This variant has, however, a smaller rotation range of the manipulator as compared to a motor actuator. The manipulator axis 8c may be parallel or, preferably, coaxial with a pivot axis of the hinge J of the lid E attached to the funnel C of the filtration unit A. The manipulator 8 is thus movable/rotatable in a single degree of freedom which considerably simplifies the kinematics and structure as well as the robustness and speed as compared to a multi-degree-kinematic robot arm.

In one variant the manipulator arm 8a supports a suction cup 8b for engaging with a portion of an outer surface of the lid E to selectively grab and release the lid. As shown in FIG. 7 in magnification, the suction cup 8b is preferably arranged about midway between the manipulator axis 8c and a leading pushing end 8e of the manipulator arm 8a that is preferably curved or spoon-or bridge-shaped to extend above and over the lid to provide clearance for the suction cup 8b. The contact plane 8g defined by the peripheral rim of the suction cup 8b is slightly displaced from a contact plane or contact point 8h of the leading pushing end 8e towards the side of the lid by an offset X.

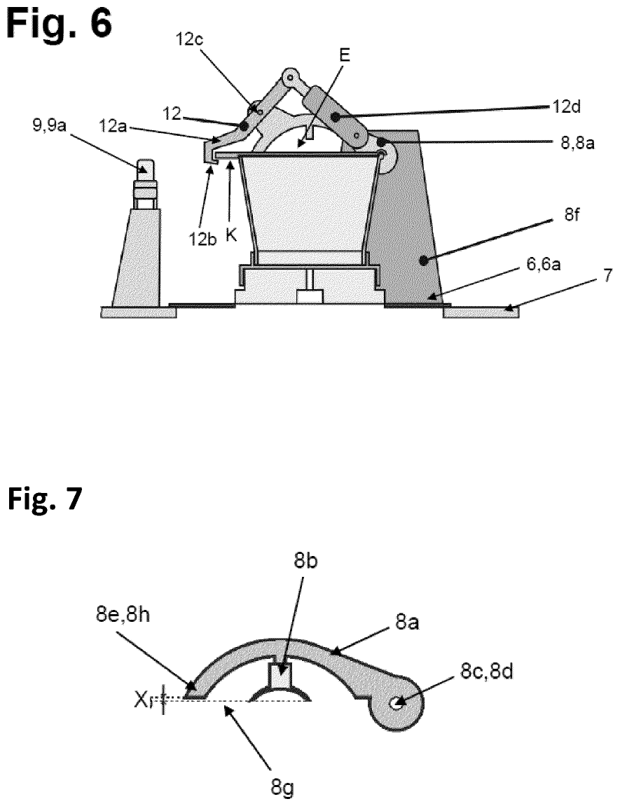

In another possible variant of the manipulator 8 shown in FIG. 6, the suction cup on the manipulator arm 8a may be replaced by a mechanical lever arrangement 12 that is included on the manipulator arm 8a and that mainly comprises a mobile finger 12a pivotable about an axis 12c defined about midway in the axial extension of the mobile finger 12a. The axis 12c is provided in a leading or forward section of the manipulator arm.

At a leading end of the mobile finger 12a is formed a small hook 12b and a linear actuator 12d links a distal or rear end of the mobile finger 12a with the manipulator arm 8a at a rearward portion near the manipulator axis 8c. When the linear actuator 12d contracts and thus pulls on the mobile finger 12a, the mobile finger 12a turns clockwise and the hook 12b frees and disengages from the tab K protruding from a peripheral edge of the lid or from the peripheral edge itself. When the linear actuator 12d expands and thus pushes the mobile finger 12a, the mobile finger 12a turns counter-clockwise and the shape of the hook 12b and its kinematics unlocks the lid E of the filtration unit A from the form-locking or snap-fit engagement with the peripheral rim or edge of the funnel C in an initial phase of opening the lid, thus functioning as an unlocking actuator 9,9b, or lifts the whole lid when needed. In this phase the lid remains engaged with the manipulator arm 8a in that it rests against the leading pushing end 8e. Thus, the manipulator arm provides a certain balanced and controlled counterforce against the force acting on the lid by operation of the unlocking actuator to avoid sudden uncontrolled “popping up” of the lid when the unlocking actuator overcomes the holding force of the form-locking or snap-fit connection.

Further rotation of the lid engaged with the manipulator arm 8a is then effected by selectively driving the manipulator arm 8a for rotation about the manipulator axis 8c in opposite directions as described above by means of a manipulator actuator 8f.

The filtration system 1 as shown in FIGS. 1 to 5 preferably comprises another variant of a dedicated unlocking actuator 9,9a configured to initially unlock the lid E from the form-locking or snap-fit engagement with the peripheral rim or edge of the funnel C, preferably by applying an upward pulling or pushing force onto a section of an outer peripheral portion of the lid E (which may either be the tab K protruding from the peripheral edge of the lid or the peripheral edge itself as described above).

Such unlocking actuator 9,9a is, for example, mounted on a separate swiveling arm 13 arranged to be driven for rotation by an actuator 14 supported on the system frame (not shown) that can either position the unlocking actuator under the tab K or edge or in a retracted position (see FIG. 2). This allows to free the area around the filtration unit to facilitate its introduction to the receptacle 2a of the support 2 and its removal from the support 2, respectively at the beginning and at the end of the filtration process. The swiveling arm may be replaced and/or combined with a linearly expandable/retractable arm or an eccentric driver (not shown) or any other mechanical device that provides the above described function of selectively moving the unlocking actuator towards and away from the filtration unit locked to the support 2.

In an alternative mode of embodiment shown in FIG. 3, the unlocking actuator can be included in an arrangement of moving jaws 10 that are configured to selectively engage with the outer periphery of the filtration unit A, i.e. the funnel or the base or both, by linearly expanding or retracting arms 15 to which the jaws 10 are mounted, under the action of an actuator 16 supported on the system frame (not shown). The shape and structure of the jaws may be adapted or conformed to the outer shape of the filtration unit used.

The unlocking actuator 9,9a is preferably mounted to one of the jaws 10 so that operation of the jaws 10 into engagement with the outer periphery of the filtration unit A automatically brings the unlocking actuator in its operative position relative to the lid. The linearly expanding or retracting arms 15 may be replaced and/or combined with swiveling arms or an eccentric driver (not shown) or any other mechanical device that provides the above described function of selectively moving the jaws 10 and the unlocking actuator towards and away from the filtration unit locked to the support 2.

The operation of the arrangement of jaws 10 is preferably coordinated with the operation of the mechanical manipulator 8 and/or the unlocking actuator 9,9a to allow to firmly maintain the filtration unit in the fixed arrangement on the support 2 while unlocking the lid with the unlocking actuator. The arrangement of jaws 10 may of course be provided independent from the concept of the unlocking actuator used in the system to enhance the secure fixing of the filtration unit on the support at the initial stage of opening of the lid or during all or selected stages of the filtration process.

The operation of the unlocking actuator 9,9a,9b is preferably coordinated with the operation of the mechanical manipulator 8 in the sense that the mechanical manipulator 8 is engaged with the lid first and provides a certain balanced and controlled counterforce against the force acting on the lid by operation of the unlocking actuator to avoid sudden uncontrolled “popping up” of the lid when the unlocking actuator overcomes the holding force of the form-locking or snap-fit connection.

To coordinate the operation of the individual components of the filtration system within a defined schedule to autonomously perform the filtration process, the filtration system 1 comprises a controller arranged to communicate with the weighing sensor or scale 5, the locking means 2b of the support 2, the mechanical manipulator 8, if provided, and the unlocking actuator 9,9a,9b, if provided. The controller is configured, i.e. programmed, to trigger operation and control the operation of these components autonomously based on the detection/monitoring result of the weighing sensor 5 over time and a predefined operation sequence defining the filtration process. The controller may be an integral part of the system or may be located at a remote location.

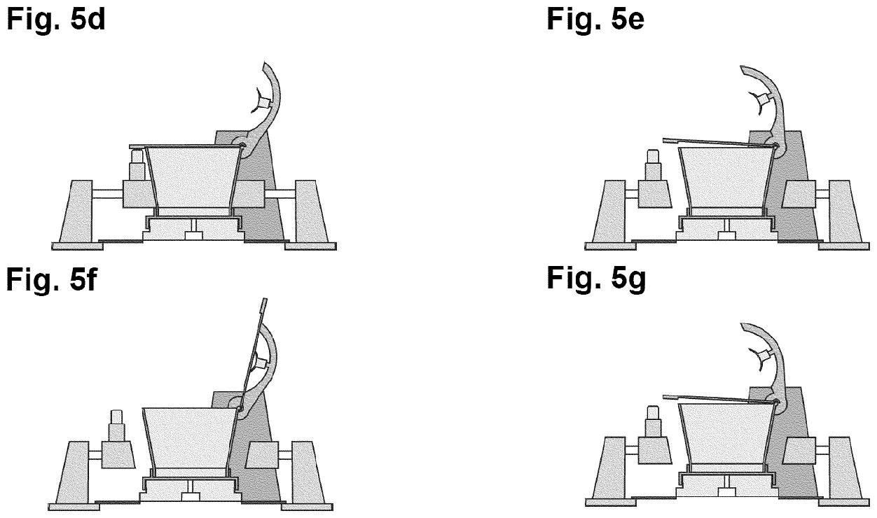

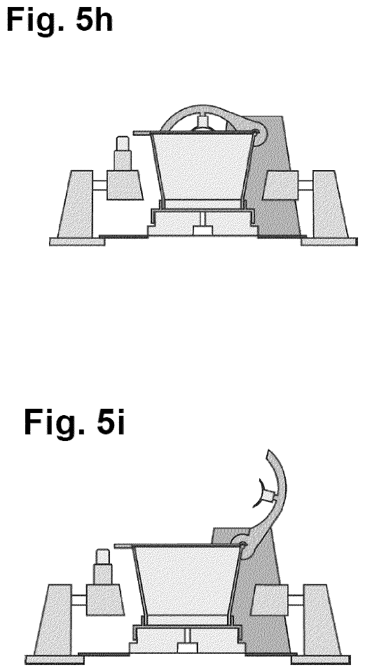

The typical autonomous and automatic filtration process performed by the filtration system described above will now be described for the first and second embodiments by reference to the sequence of FIGS. 4a to 4i and 5a to 5i that respectively show a sequence of characteristic steps of the process and omitting parts of the system that are not necessary to explain the basic function:
FIG. 4a—Step 1: the filtration system is ready to receive a new filtration unit with the unlocking actuator 9,9a in a retracted position and the manipulator arm 8a in an open position.
FIG. 4b—Step 2: a filtration unit A is placed on the receptacle 2a of the support 2 by an external apparatus. The hinge axis of the lid of the filtration unit is aligned with the manipulator axis 8c, i.e. is arranged to be parallel or preferably concentric. At this step, the weighing sensor 5 is used to detect the presence of the filtration unit A on the support 2. Then, the locking means 2b is activated to fix, i.e. hold down the filtration unit A on the receptacle 2a.
FIG. 4c—Step 3: the manipulator arm 8a is rotated down to come in contact with the lid of the filtration unit in order to apply a mechanical force on it. It allows to ensure that the filtration unit is properly inserted on the receptacle 2a of the support 2.
FIG. 4d—Step 4: while the manipulator arm 8a keeps a mechanical force applied to the lid of the filtration unit, the swiveling arm 13 is moved to place the unlocking actuator 9a under the tab K of the lid E of the filtration unit. The unlocking actuator 9a then pushes-up the tab which at least partly unlocks the lid from the peripheral edge of the funnel of the filtration unit.
FIG. 4e—Step 5: the manipulator arm 8a is raised in open position to tare the weighing sensor 5 and the unlocking actuator 9a is moved away in its retracted position.
FIG. 4f—Step 6: the manipulator arm 8a is moved down to put the suction cup 8b in contact with the unlocked lid and to lift it up into a stable opened position. The suction cup vacuum is inactivated and the manipulator arm 8a is slightly rotated away from the lid. Then, an external apparatus puts the liquid to be tested/filtrated into the funnel of the filtration unit. The amount of transferred liquid is monitored by the weighing sensor 5 until the requested amount of liquid has been discharged.
FIG. 4g—Step 7: the manipulator arm 8a is momentarily rotated down to put the lid of the filtration unit in its “closed but not locked” filtration position. This allows to shorten to a minimum the exposure of the inside of the filtration unit to the environment. Then the aspiration pump 4 is activated to proceed with the filtration of the liquid in the funnel of the filtration unit. The weighing sensor 5 is used to monitor the filtration process, assessing that the filtration follows the expected profile/schedule and detects the end of the filtration.
FIG. 4h—Step 8: when the filtration is finished, the manipulator arm 8a is rotated down to lock down the lid of the Filtration unit on the funnel. This allows to protect the inside of the filtration unit while producing a slight compression of the air in the space of the funnel of the filtration unit. This allows to gently push out the filtration membrane on the base of the filtration unit facilitating the subsequent transfer to a gelled culture media (for example).
FIG. 4i—Step 9: the manipulator arm 8a is rotated up into its opened position. This frees the surrounding of the filtration unit to facilitate its extraction. Then, the locking means 2b is deactivated to free the filtration unit A on the receptacle 2a and allow its removal by an external apparatus.

The filtration process performed by the filtration system of the second embodiment is explained by reference to the sequence of FIGS. 5a to 5i which correspond to that of FIGS. 4a to 4i excepted for steps 4 and 5 in FIGS. 5d and 5e (therefore, the detailed description of the identical steps is not repeated):
FIG. 5d—Step 4: the jaws 10 are moved towards the filtration unit to apply a mechanical holding force on the funnel of the filtration unit. The movement of the jaws simultaneously places the unlocking actuator 9b under the tab of the lid of the filtration unit. The unlocking actuator 9b then pushes-up the tab which unlocks the lid of the filtration unit.
FIG. 5e—Step 5: the jaws 10 are opened and then the lid of the Filtration unit is opened. The weighing sensor is tared.

On this basis the invention provides, in a generalized manner, an automated autonomous filtration process for testing liquids using consumable filtration units A of the type described above using a filtration system 1 according to the invention that includes the mechanical manipulator 8 and the unlocking actuator 9; 9a; 9b, which filtration process comprises the following steps, preferably in sequence:
a) placing the filtration unit A on the support 2, preferably by an external apparatus, detecting the presence of the filtration unit A on the support 2 using the weighing sensor 5, and, in the affirmative, operating the locking means 2b to fix the filtration unit A on the receptacle 2a of the support 2;
b) operating (preferably rotating) the manipulator arm 8a of the mechanical manipulator 8 to engage with a portion of the lid E, and applying a force onto the lid E in the closing direction thereof;
c) engaging the unlocking actuator 9; 9a; 9b with a section of an outer peripheral portion of the lid E (i.e. a tab, if provided) and applying an upward pulling or pushing force to the section to unlock the lid E from engagement with a rim of the funnel C while maintaining application of a certain force onto the lid E in the closing direction by the mechanical manipulator 8;
d) disengaging and separating the unlocking actuator 9; 9a; 9b and the manipulator arm 8a of the mechanical manipulator 8 from the lid E and taring the weighing sensor 5;
e) operating (preferably rotating) the manipulator arm 8a of the mechanical manipulator 8 to engage with the portion of the lid E, and applying a force onto the lid E in the opening direction thereof;
f) introducing a defined amount of the liquid to be tested into the space H of the funnel C, preferably using the weighing sensor 5 to monitor and control the introduced amount;
g) operating (preferably rotating) the manipulator arm 8a of the mechanical manipulator 8 and applying a force onto the lid E in the closing direction to bring the lid E into a posture where it preferably substantially closes the opening of the funnel C but is in any case not locked to the rim of the funnel C;
h) withdrawing the liquid to be tested from the funnel C through the liquid flow path 3 via the membrane D and the drain F of the filtration unit A using a pump 4 connected to the other side 3b of the liquid flow path 3, preferably using the weighing sensor 5 to monitor and control the withdrawn amount;
i) operating (preferably rotating) the manipulator arm 8a of the mechanical manipulator 8 and applying a force onto the lid E in the closing direction to bring the lid E into a posture where it is locked to the rim of the funnel C; and
j) disengaging and separating the manipulator arm 8a of the mechanical manipulator 8 from the lid E, operating the locking means 2b to release fixation of the filtration unit A on the receptacle 2a of the support 2, and removing the filtration unit A from the support 2, preferably by an external apparatus.

In a situation where a filtration unit with a hinged lid is used, the automated filtration process comprises, in step a) when the filtration unit is placed on the receptacle of the support or afterwards in a separate action, aligning an axis of the hinge J of the lid E with the manipulator axis 8c of the manipulator arm 8a of the mechanical manipulator 8 before operating the locking means 2b to fix the filtration unit A on the support 2.

In a situation where the filtration system is equipped with locking jaws 10 as described above in connection with the second embodiment, the automated filtration process comprises in step c), engaging the arrangement of the jaws 10 with the outer periphery of the filtration unit A before engaging the unlocking actuator 9; 9a; 9b with the section of the outer peripheral portion of the lid E and applying the upward pulling or pushing force to the section to unlock the lid E from engagement with the rim of the funnel C. In step d), the process comprises disengaging the arrangement of jaws 10 from the outer periphery of the filtration unit A, before taring the weighing sensor 5.

While the invention is described in connection with two basic embodiments and variants, the disclosure should comprise combinations of components or features that can be used together in a useful manner to enhance the operation and function of the system and are not true alternatives.

1. A filtration system (1) for testing liquids using consumable filtration units (A), such filtration units (A) each comprising a base (B) with a drain (F), a funnel (C) attached to the base (B), a membrane (D) arranged on the base (B) between a space (H) defined by the funnel (C) and the drain (F), and a lid (E) for closing an upper opening of the funnel (C), the filtration system (1) comprising:
a support (2) for receiving the consumable filtration unit (A), the support (2) including locking means (2b) configured to releasably fix the filtration unit (A) on the support (2);
a liquid flow path (3) having one side (3a) communicating with a downstream side of the drain (F) when the filtration unit (A) is fixed to the support (2), another side (3b) of the liquid flow path (3) adapted to be connected to a pump (4) for withdrawing liquid from the drain (F) when the filtration unit (A) is fixed to the support (2); and
a weighing sensor (5) arranged to detect the weight of the filtration unit (A) fixed to the support (2).

2. The filtration system (1) according to claim 1, wherein the weighing sensor (5) is arranged to monitor the combined weight of the support (2) with the filtration unit (A) fixed to the support (2).

3. The filtration system (1) according to claim 2, further comprising an elastic support element (6) that connects the support (2) to a fixed frame or base (7) so as to provide for motion of the support (2) in the direction of gravity.

4. The filtration system (1) according to claim 3, wherein the elastic support element (6) comprises an elastic foil or membrane (6a) arranged so as to shield components below the support (2) from spillage of liquid from the filtration unit (A).

5. The filtration system (1) according to claim 1, further comprising a mechanical manipulator (8) for selectively engaging with the lid (E) on the filtration unit (A) and for moving the engaged lid (E) to selectively open/close the upper opening of the funnel (C).

6. The filtration system (1) according to claim 5, wherein the mechanical manipulator (8) comprises a manipulator arm (8a) configured to selectively engage with a portion of the lid (E), the manipulator arm (8a) being pivotable around a horizontal manipulator axis (8c).

7. The filtration system (1) according to claim 6, wherein the manipulator arm (8a) supports a suction cup (8b) for engaging with a portion of an outer surface of the lid (E).

8. The filtration system (1) according to claim 1, further comprising an unlocking actuator (9; 9a; 9b) configured to initially unlock the lid (E) from engagement with a rim of the funnel (C).

9. The filtration system (1) according to claim 5, further comprising an unlocking actuator (9; 9a; 9b) configured to initially unlock the lid (E) from engagement with a rim of the funnel (C), wherein the operation of the unlocking actuator (9; 9a; 9b) is coordinated with the operation of the mechanical manipulator (8).

10. The filtration system (1) according to claim 9, further comprising an arrangement of jaws (10) configured to selectively engage with the outer periphery of the filtration unit (A).

11. The filtration system (1) according to claim 10, wherein the unlocking actuator (9; 9a) is mounted to one of the jaws (10).

12. The filtration system (1) according to claim 9, comprising a controller arranged to communicate with the weighing sensor (5), the locking means (2b) of the support (2), the mechanical manipulator (8), and the unlocking actuator (9; 9a; 9b), the controller configured to control the operation of these components autonomously based on the detection result of the weighing sensor (5) and a predefined operation sequence.

13. An automated filtration process for testing liquids using consumable filtration units (A), such filtration units (A) each comprising a base (B) with a drain (F), a funnel (C) attached to the base (B), a membrane (D) arranged on the base (B) between a space (H) defined by the funnel (C) and the drain (F), and a lid (E) for closing an upper opening of the funnel (C), and using a filtration system (1) according to claim 12, the filtration process comprising the following steps:
a) placing the filtration unit (A) on the support (2), detecting the presence of the filtration unit (A) on the support (2) using the weighing sensor (5), and, in the affirmative, operating the locking means (2b) to fix the filtration unit (A) on the support (2);
b) operating the manipulator arm (8a) of the mechanical manipulator (8) to engage with a portion of the lid (E), and applying a force onto the lid (E) in the closing direction thereof;
c) engaging the unlocking actuator (9; 9a; 9b) with a section of an outer peripheral portion of the lid (E) and applying an upward pulling or pushing force to the section to unlock the lid (E) from engagement with a rim of the funnel (C) while maintaining application of a certain force onto the lid (E) in the closing direction by the mechanical manipulator (8);
d) disengaging and separating the unlocking actuator (9; 9a; 9b) and the manipulator arm (8a) of the mechanical manipulator (8) from the lid (E) and taring the weighing sensor (5);
e) operating the manipulator arm (8a) of the mechanical manipulator (8) to engage with the portion of the lid (E), and applying a force onto the lid (E) in the opening direction thereof;
f) introducing a defined amount of the liquid to be tested into the space (H) of the funnel (C);
g) operating the manipulator arm (8a) of the mechanical manipulator (8) and applying a force onto the lid (E) in the closing direction to bring the lid (E) into a posture where it substantially closes the opening of the funnel (C) but is in any case not locked to the rim of the funnel (C);
h) withdrawing the liquid to be tested from the funnel (C) through the liquid flow path (3) via the membrane (D) and the drain (F) of the filtration unit (A) using a pump (4) connected to the other side (3b) of the liquid flow path (3);
i) operating the manipulator arm (8a) of the mechanical manipulator (8) and applying a force onto the lid (E) in the closing direction to bring the lid (E) into a posture where it is locked to the rim of the funnel (C); and
j) disengaging and separating the manipulator arm (8a) of the mechanical manipulator (8) from the lid (E), operating the locking means (2b) to release fixation of the filtration unit (A) on the support (2), and removing the filtration unit (A) from the support (2).

14. The automated filtration process according to claim 13, wherein, in step a), an axis of a hinge (J) of the lid (E) is aligned with the manipulator axis (8c) of the manipulator arm (8a) of the mechanical manipulator (8) before operating the locking means (2b) to fix the filtration unit (A) on the support (2).

15. The automated filtration process according to claim 13, wherein the filtration system (1) further comprises an arrangement of jaws (10) configured to selectively engage with the outer periphery of the filtration unit (A), and wherein:
in step c), the arrangement of jaws (10) is engaged with the outer periphery of the filtration unit (A) before engaging the unlocking actuator (9; 9a; 9b) with the section of the outer peripheral portion of the lid (E) and applying the upward pulling or pushing force to the section to unlock the lid (E) from engagement with the rim of the funnel (C); and
in step d), the arrangement of jaws (10) is disengaged from the outer periphery of the filtration unit (A) before taring the weighing sensor (5).

16. The automated filtration process according to claim 13, wherein the weighing sensor (5) is used to monitor and control at least one of the amount introduced in step f) and the amount withdrawn in step h).

17. The filtration system (1) according to claim 6, wherein the horizontal manipulator axis (8c) is parallel or coaxial with a pivot axis of the lid (E) attached to the funnel (C) of the filtration unit (A).

18. The filtration system (1) according to claim 8, wherein the unlocking actuator (9; 9a; 9b) is configured to initially unlock the lid (E) from engagement with a rim of the funnel (C) by applying an upward pulling or pushing force onto a section of an outer peripheral portion of the lid (E).

19. The filtration system (1) according to claim 8, further comprising an arrangement of jaws (10) configured to selectively engage with the outer periphery of the filtration unit (A), wherein the unlocking actuator (9; 9a) is mounted to one of the jaws (10).

20. The filtration system (1) according to claim 10, wherein the operation of the arrangement of jaws (10) is coordinated with the operation of at least one of the mechanical manipulator (8) and the unlocking actuator (9; 9a; 9b).
